(19) United States
(12) Patent Application Publication
(10) Pub. No.: US 2020/0097421 A1
(43) Pub. Date: Mar. 26, 2020

(54) DATA FAST PATH IN HETEROGENEOUS SOC

(71) Applicant: Samsung Electronics Co., Ltd., Suwon-si (KR)

(72) Inventors: Hien LE, Cedar Park, TX (US); Vikas Kumar SINHA, Austin, TX (US); Craig Daniel EATON, Austin, TX (US); Anushkumar RENGARAJAN, Austin, TX (US); Matthew Derrick GARRETT, Austin, TX (US)

(21) Appl. No.: 16/200,622

(22) Filed: Nov. 26, 2018

Related U.S. Application Data
(60) Provisional application No. 62/734,237, filed on Sep. 20, 2018.

(51) Int. Cl. G06F 13/16; G06F 1/12; G06F 12/0815

(52) U.S. Cl. CPC G06F 13/1689; G06F 2212/1032; G06F 12/0815; G06F 1/12

(57) ABSTRACT

According to one general aspect, an apparatus may include a processor coupled with a memory controller via a first path and a second path. The first path may traverse a coherent interconnect that couples the memory controller with a plurality of processors, including the processor. The second path may bypass the coherent interconnect and has a lower latency than the first path. The processor may be configured to send a memory access request to the memory controller and wherein the memory access request includes a path request to employ either the first path or the second path. The apparatus may include the memory controller configured to fulfill the memory access request and, based at least in part upon the path request, send at least part of the results of the memory access to the processor via either the first path or the second path.

### CROSS-REFERENCE TO RELATED APPLICATION

This application claims priority under 35 U.S.C. § 119 to Provisional Patent Application Ser. No. 62/734,237, entitled “DATA FAST PATH IN HETEROGENEOUS SOC” filed on Sep. 20, 2018. The subject matter of this earlier filed application is hereby incorporated by reference.

### TECHNICAL FIELD

This description relates to computer data management, and more specifically to data fast path in heterogeneous system-on-a-chip (SOC).

### BACKGROUND

A system on a chip or system on chip (SoC) is an integrated circuit (IC) that integrates all (or most of) the components of a computer or other electronic system. These components typically include a central processing unit (CPU), memory, input/output ports and, maybe, secondary storage—all on a single substrate. It may contain digital, analog, mixed-signal, and often radio frequency signal processing functions, depending on the application. As they are integrated on a single electronic substrate, SoCs consume much less power and take up much less area than multi-chip designs with equivalent functionality. Because of this, SoCs are very common in the mobile computing and edge computing markets. Systems on chip are commonly used in embedded systems and the Internet of Things.

A memory controller is a digital circuit that manages the flow of data going to and from the computer's main memory. A memory controller can be a separate chip or integrated into another chip, such as being placed on the same die or as an integral part of a microprocessor. Memory controllers contain the logic necessary to read and write to DRAM (dynamic random access memory).

In computer architecture, cache or memory coherence is the uniformity of shared resource data that ends up stored in multiple local caches. When clients in a system maintain caches of a common memory resource, problems may arise with incoherent data, which is particularly the case with CPUs in a multiprocessing system. In a shared memory multiprocessor system with a separate cache memory for each processor, it is possible to have many copies of shared data: one copy in the main memory and one in the local cache of each processor that requested it. When one of the copies of data is changed, the other copies must reflect that change. Cache coherence is the discipline which ensures that the changes in the values of shared operands (data) are propagated throughout the system in a timely fashion.

### SUMMARY

According to one general aspect, an apparatus may include a processor coupled with a memory controller via a first path and a second path. The first path may traverse a coherent interconnect that couples the memory controller with a plurality of processors, including the processor. The second path may bypass the coherent interconnect and has a lower latency than the first path. The processor may be configured to send a memory access request to the memory controller and wherein the memory access request includes a path request to employ either the first path or the second path. The apparatus may include the memory controller configured to fulfill the memory access request and, based at least in part upon the path request, send at least part of the results of the memory access to the processor via either the first path or the second path.

According to another general aspect, a system may include a heterogeneous plurality of processors coupled with a memory controller via at least a slow path, wherein at least a requesting processor of the plurality of processors is coupled with the memory controller via both the slow path and a fast path, wherein the slow path traverses a coherent interconnect that couples the memory controller with the plurality of processors, and wherein the fast path bypasses the coherent interconnect and has a lower latency than the slow path. The system may include the coherent interconnect configured to couple the plurality of processors with a memory controller and facilitate cache coherency between the plurality of processors. The system may include the memory controller configured to fulfill a memory access request from the requesting processor, and, based at least in part upon a path request message, send at least part of the results of the memory access to the requesting processor via either the first path or the second path.

According to another general aspect, a memory controller may include a slow path interface configured to, in response to a memory access, send at least a response message to a requesting processor, wherein the slow path traverses a coherent interconnect that couples the memory controller with a requesting processor. The memory controller may include a fast path interface configured to, at least partially in response to the memory access, send data to a requesting processor, wherein the fast path coupled the memory controller with the requesting processor, and bypasses the coherent interconnect, and wherein the fast path has a lower latency that the slow path. The memory controller may include a path routing circuit configured to: receive, as part of the memory access, a data path request from the coherent interconnect, based at least in part upon a result of the memory access and the data path request, determine whether the data is to be sent via the slow path or the fast path. The memory controller is configured to: if the path routing circuit determines that data is to be sent via the slow path, send both the data and the response message to the requesting processor via the slow path interface, and if the path routing circuit determines that data is to be sent via the fast path, send the data to the requesting processor via the fast path interface, and the response message to the requesting processor via the slow path interface.

The details of one or more implementations are set forth in the accompanying drawings and the description below. Other features will be apparent from the description and drawings, and from the claims.

A system and/or method for computer data management, and more specifically to data fast path in heterogeneous system-on-a-chip (SOC), substantially as shown in and/or described in connection with at least one of the figures, as set forth more completely in the claims.

### BRIEF DESCRIPTION OF THE DRAWINGS

FIG. 1 is a block diagram of an example embodiment of a system in accordance with the disclosed subject matter.

FIG. 2A is a block diagram of an example embodiment of a system in accordance with the disclosed subject matter.

FIG. 2B is a block diagram of an example embodiment of a system in accordance with the disclosed subject matter.

FIG. 3 is a block diagram of an example embodiment of a system in accordance with the disclosed subject matter.

FIG. 4 is a flowchart of an example embodiment of a technique in accordance with the disclosed subject matter.

FIG. 5 is a schematic block diagram of an information processing system that may include devices formed according to principles of the disclosed subject matter.

Like reference symbols in the various drawings indicate like elements.

### DETAILED DESCRIPTION

Various example embodiments will be described more fully hereinafter with reference to the accompanying drawings, in which some example embodiments are shown. The present disclosed subject matter may, however, be embodied in many different forms and should not be construed as limited to the example embodiments set forth herein. Rather, these example embodiments are provided so that this disclosure will be thorough and complete, and will fully convey the scope of the present disclosed subject matter to those skilled in the art. In the drawings, the sizes and relative sizes of layers and regions may be exaggerated for clarity.

It will be understood that when an element or layer is referred to as being “on,” “connected to” or “coupled to” another element or layer, it may be directly on, connected or coupled to the other element or layer or intervening elements or layers may be present. In contrast, when an element is referred to as being “directly on”, “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, and so on may be used herein to describe various elements, components, regions, layers and/or sections, these elements, components, regions, layers and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of the present disclosed subject matter.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” may encompass both an orientation of above and below. The device may be otherwise oriented (rotated 90 degrees or at other orientations) and the spatially relative descriptors used herein interpreted accordingly.

Likewise, electrical terms, such as “high” “low”, “pull up”, “pull down”, “1”, “0” and the like, may be used herein for ease of description to describe a voltage level or current relative to other voltage levels or to another element(s) or feature(s) as illustrated in the figures. It will be understood that the electrical relative terms are intended to encompass different reference voltages of the device in use or operation in addition to the voltages or currents depicted in the figures. For example, if the device or signals in the figures are inverted or use other reference voltages, currents, or charges, elements described as “high” or “pulled up” would then be “low” or “pulled down” compared to the new reference voltage or current. Thus, the exemplary term “high” may encompass both a relatively low or high voltage or current. The device may be otherwise based upon different electrical frames of reference and the electrical relative descriptors used herein interpreted accordingly.

The terminology used herein is for the purpose of describing particular example embodiments only and is not intended to be limiting of the present disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present disclosed subject matter.

Unless otherwise defined, all terms (including technical and scientific terms) used herein have the same meaning as commonly understood by one of ordinary skill in the art to which this disclosed subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings.

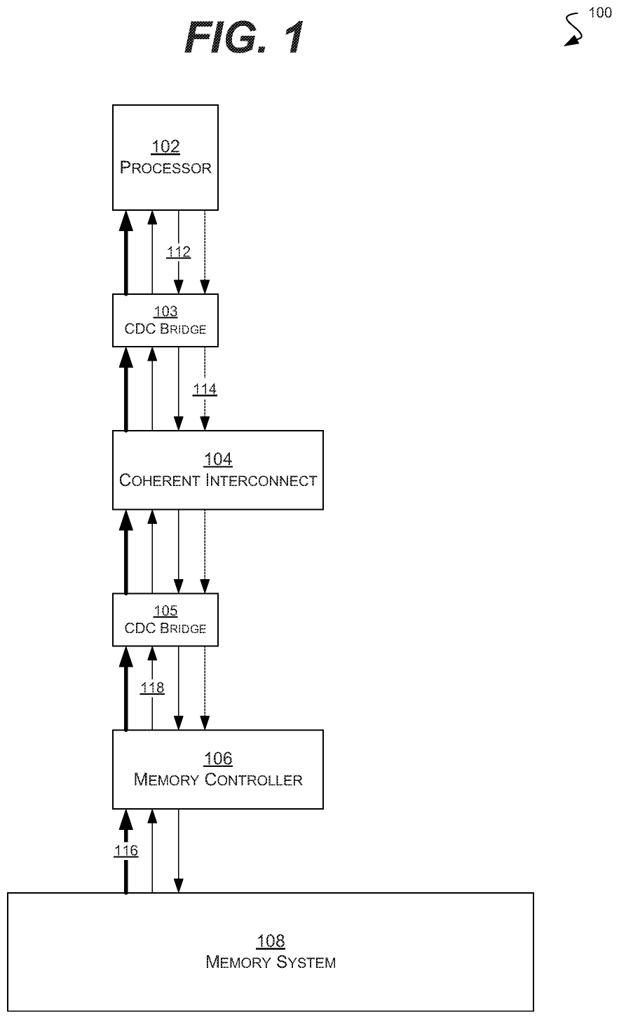

FIG. 1 is a block diagram of an example embodiment of a system 100 in accordance with the disclosed subject matter. In the illustrated embodiment, the operation of the system 100 a simplified, single processor, traditional usage case is described. Further figures describe more complex usage cases.

In various embodiments, the system 100 may include a system-on-a-chip. In another embodiment, the system 100 may be one or more discrete components in a more traditional computer system, such as, for example, a laptop, desktop, workstation, personal digital assistant, smartphone, tablet, and other appropriate computers or a virtual machine or virtual computing device thereof.

In the illustrated embodiment, the system 100 may include a processor 102. The processor 102 may be configured to execute one or more instructions. As part of those instructions, the processor 102 may request data from the memory system 108. In the illustrated embodiment, to initiate this memory access the processor 102 may send or transmit a read request message 112 to the memory controller. In such an embodiment, the read request message 112 may include the memory address the data is to be read from and the amount of data requested. In various embodiments, the read request message 112 may also include other information, such as, the way in which the data is to be delivered, a timing of the request, and so on.

In this context, a “memory access” may include either reads, writes, deletions, or coherency operations, such as, for example, snoops or invalidates. It is understood that the above are merely a few illustrative examples to which the disclosed subject matter is not limited.

In the illustrated embodiment, the system 100 may include a coherent interconnect 104. In various embodiments, the coherent interconnect 104 may be configured to coupled one or more processors 102 with the memory controller 106, and, in some embodiments, provide or facilitate cache or memory coherency operations by those multiple processors. In the illustrated embodiment, only one processor 102 is shown, and the coherency functions of the coherent interconnect 104 may be ignored.

However, in various embodiments, the processor 102 and the coherent interconnect 104 may operate on different clock domains or frequencies. As such, the system 100 may include a clock-domain-crossing (CDC) bridge 103 that is configured to synchronize data from one clock domain (e.g., the processor 102's) to another clock domain (e.g., the coherent interconnect 104's), and vice versa. In various embodiments, the CDC bridge 103 may include, in a simple embodiment, a series of back-to-back flip-flops or other synchronizing circuit operating on the various clock domains. For example, one or two back-to-back flip-flops may use the processor 102's clock and then be immediately followed by two back-to-back flip-flops using the coherent interconnect 104's clock. It is understood that the above is merely one illustrative example to which the disclosed subject matter is not limited.

In the illustrated embodiment, the system 100 may include the memory control 106. In various embodiments, the memory controller 106 may manage access to the memory system 108. In various embodiments, the memory system 108 may include the system memory (e.g., DRAM), a cache for the SOC, or may include a number of memory tiers. In either case, for the purposes of the processor 102 the memory system 108 may be where most, if not all, of the data used by the system 100 is stored or the repository through which it is available. In such an embodiment, the memory controller 106 may be the gateway to that repository.

Again, the coherent interconnect 104 and the memory controller 106 may operate within different clock domains. In such an embodiment, the system 100 may include a CDC bridge 105 that converts from the memory controller 106's clock to the coherent interconnect 104's, and vice versa.

Upon receiving the memory access or read request 112, the memory controller 106 may initiate the read memory access. Assuming the read operation occurs without incident, the memory system 108 may return the data 116 to the memory controller 106. In addition, a read response message 118 may be created by the memory controller 106. In various embodiments, this read response message 118 may indicate whether or not the read request 112 was successful, if the returned data is being split into multiple messages, if the read request 112 must be retried, or a host of other information regarding the success and completion of the read request 112.

In the illustrated embodiment, the memory controller 106 may send the data 116 and the read response message 118 back to the requesting processor 102. In the illustrated embodiment, these messages 116 and 118 may traverse the CDC bridge 105, the coherent interconnect 104, and the CDC bridge 103 before reaching the processor 102.

This return path passes through a number of circuits, each with their own delays and latencies. Specifically, the CDC bridges 103 and 105 each add multiple clock cycles of latency merely synchronizing the message 116 and 118 to new clock domains. This is not to ignore the delay incurred by the interconnect 106 and other components. During this travel time the processor 102 is stalled (at least for that particular read request) and its resources are wasted.

Memory access latency is a notorious key factor in processor performance.

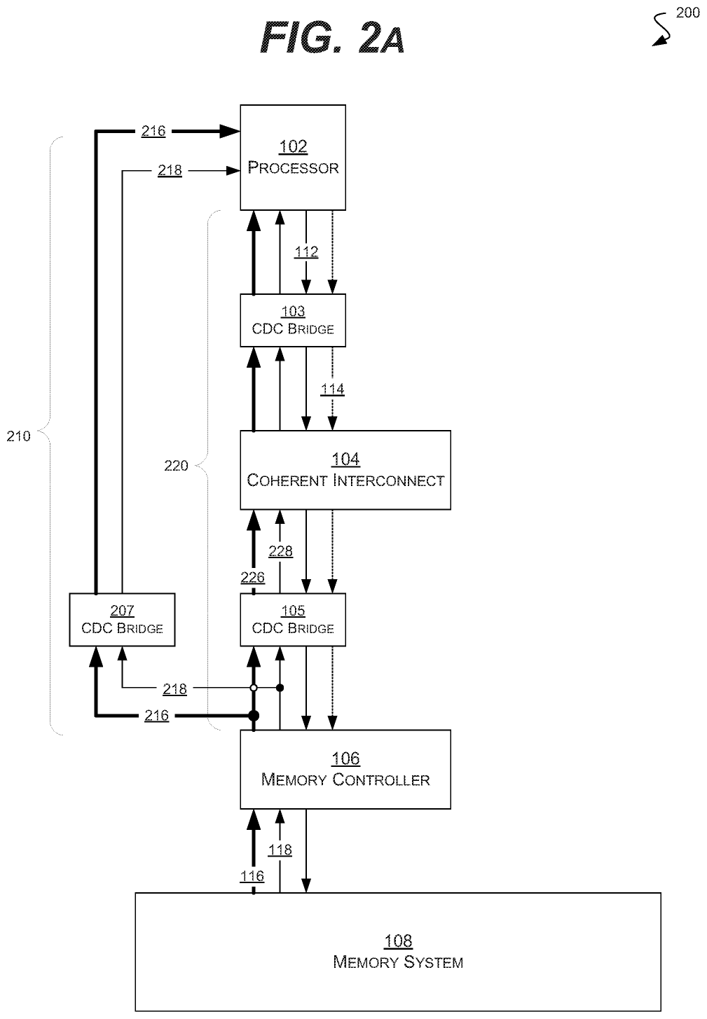

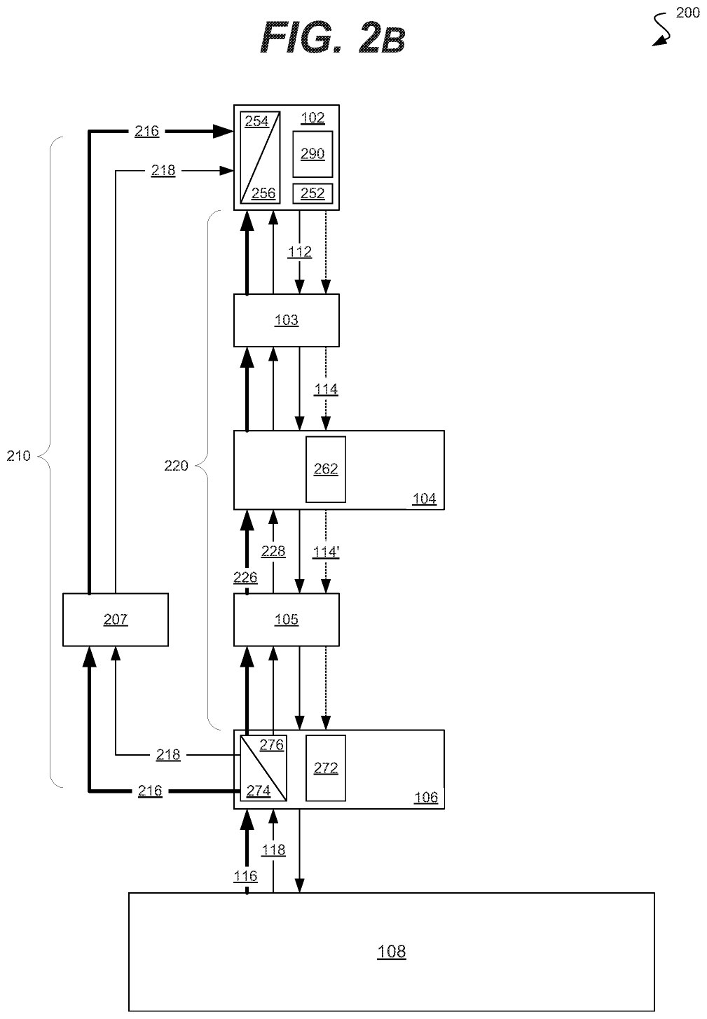

In the illustrated embodiment, the path request signal 114 is set to 0 or a default value, as there is only one path to employ in this embodiment. The path request signal 114 is discussed more in relation to FIG. 2A.

FIG. 2A is a block diagram of an example embodiment of a system 200 in accordance with the disclosed subject matter. In the illustrated embodiment, the operation of the system 200 a simplified, single processor usage case is described. However, the system 200 has been expanded to illustrate multiple paths of communicating between the requesting processor 102 and the memory controller 106.

In the illustrated embodiment, the system 200 may include the processor 102, the CDC bridge 103, the coherent interconnect 104, the CDC bridge 105, the memory controller 106, and the memory system 108, as described above. Further, in various embodiments, the processor 102 may issue a read request 112, and have the data 116 and response 118 returned via the path 220 that runs from the memory controller 106, through the interconnect 104, and to the processor 102. For the sake of clarity, the data 116 and response 118 traversing this path 220 has been renumbered as data 226 and 228, respectively. In various embodiments, this path 220 may be referred to as the slow path 220.

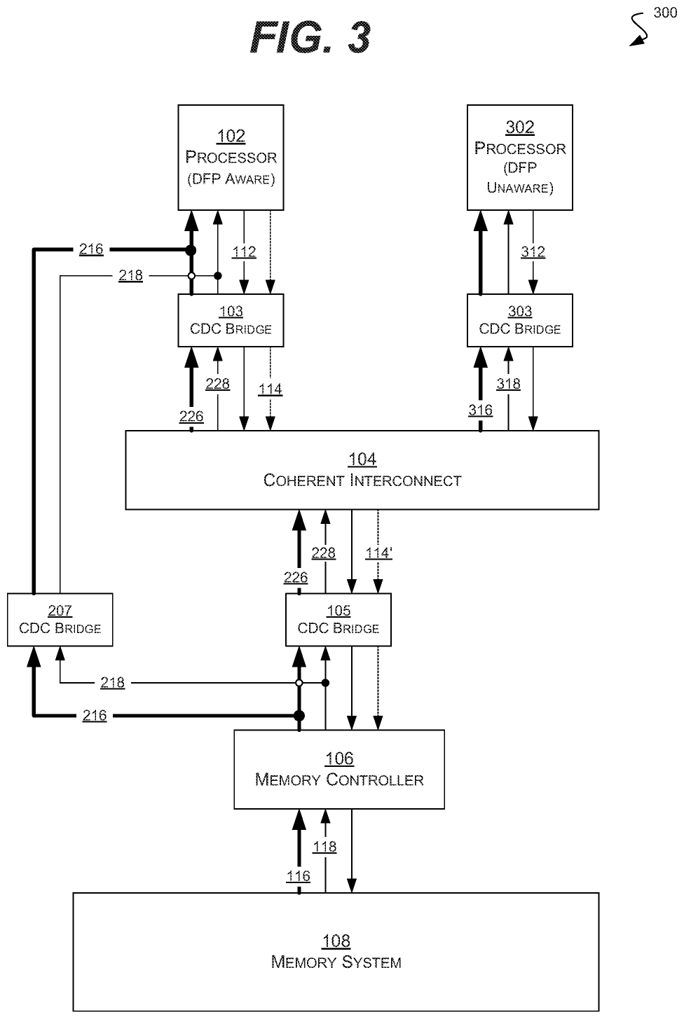

In the illustrated embodiment, the system 200 may also include a second or fast path 210. In such an embodiment, the fast path 210 may bypass the coherent interconnect 104 and thus avoid the latency of traversing the interconnect 104 and any associated CDC bridges (e.g., bridges 103 and 105). In such an embodiment, the disadvantage of this may be that the coherent interconnect 104 may not be able to perform its duties involving cache or memory coherency. However, in a single processor embodiment, such as system 200, this may be overlooked for now. It is discussed in relation to FIG. 3.

In the illustrated embodiment, the processor 102 may make the read request 112. However, in this embodiment, the processor 102 may also request that the data 116 be sent to it via the fast path 210 instead of the slow path 220. In such an embodiment, the processor 102 may set the or indicate via the path request message or signal 114 that the fast path 210 is to be employed. In various embodiments, the information represented by the path signal 114 may be included in the read request message 112.

In such an embodiment, once the memory controller 106 has successfully received the data 116 and, in some embodiments, the response 118, it may look to the path request message 114 to determine which path (slow path 220 or fast path 210) is to be employed when returning the data 116.

If the path request message 114 indicates that the slow path 220 is to be used, the memory controller 106 may return the data 226 and response 228, as described above.

If the path request message 114 indicates that the fast path 210 is to be used, the memory controller 106 may return the data 116 (now data 216) via the fast path 210. In the illustrated embodiment, the fast path may bypass the interconnect 104 and merely include the CDC bridge 207. In such an embodiment, the clock-domain-crossing (CDC) bridge 207 may be configured to synchronize data from one clock domain (e.g., the memory controller 106's) to another clock domain (e.g., the processor 102's). In such an embodiment, the latency of the interconnect 104 and the CDC bridge 103 may be avoided.

In a preferred embodiment, the read response 118 may be sent via the slow path 220 regardless of the state of the path request message or signal 114. In such an embodiment, this may be done to allow the coherent interconnect 104 to perform its duties in facilitate cache coherency.

However, in various embodiments, the memory controller 106 may send both the data 216 and the read response message 118 (now message 218) back via the fast path 210. In another embodiment, the memory controller 106 send the read response 218 back via the fast path 210 and a copy of the read response 228 back via the slow path 220. In yet another embodiment, the memory controller 106 may send back two different versions of the read response message 118. The traditionally formatted version, read response message 228, may travel via the slow path 220 and be made available by the coherent interconnect 104. While a second read response 218 that includes slightly different information (either additional information or a paired down version of the message 228) may travel via the fast path 210 for quicker processing by the processor 102. In various embodiments, the second read response signal 218 might carry coherency information, such as, for example, whether the memory line returned via the fast path 210 is either in a unique or share state. It is understood that the above are merely a few illustrative examples to which the disclosed subject matter is not limited.

In the illustrated embodiment, the signals 216 & 226, and 218 & 228 are shown as being physically connected, but in various embodiments, a circuit (e.g., a demultiplexer (DeMUX)) may separate the two signals. In such an embodiment, the un-selected signal may be set to a default value when not used. Likewise, while the signals 216 & 226, and 218 & 228 are shown as arriving at separate ports of the processor 102, in various embodiments, a circuit (e.g., a multiplexer (MUX)) or a physical merging may be employed. It is understood that the above are merely a few illustrative examples to which the disclosed subject matter is not limited.

FIG. 2B is a block diagram of an example embodiment of a system 200 in accordance with the disclosed subject matter. FIG. 2B shows some of the internal circuits of the components of system 200. Further, a multi-ported version of memory controller 108 is shown.

In the illustrated embodiment, the processor 102 may include a core 290 configured to execute instructions and comprising a number of logical block units (LBUs) or functional unit blocks (FUBs), such as, floating-point units, load-store units, etc.

In the illustrated embodiment, the processor 102 may also include a path selection circuit 252. In such an embodiment, the path selection circuit 252 may determine if the path request message 114 should be sent or should request that the fast path 210 should be employed for a read request 112. In various embodiments, the path selection circuit 252 may base its decision on the state of the core 290, the cause of the read request (e.g., prefetching, unexpected need, etc.), and a general policy or setting of the processor 102.

As described above, the processor 102 may send out the read request 112 and the path request 114.

In the illustrated embodiment, the coherent interconnect 104 may include a path allowance circuit 262. In such an embodiment, the path allowance circuit 262 may be configured to pass the path selection message 114 as is (e.g., allow the request for a fast path to continue in the system 200), or replace, block or override the path selection message 114 with a new path selection message 114′.

In various embodiments, the coherent interconnect 104 may essentially deny the processor 102's request to use the fast path 210 and replace it with a request to use the slow path 220. For example, if the interconnect 104 is aware of the existence of a copy of the same data in other processor's cache (shown in FIG. 3) or if the memory address targeted by the read request 112 does not support using the fast path 210, the interconnect 104 may send a new path selection message 114′ that indicates that the slow path 220 is to be used.

In various embodiments, each fast path aware support component (e.g., interconnect 104, memory controller 106) may be able to override or deny (or grant) the path request 114. In some embodiments, the interconnect 104 or an intervening component may not be fast path aware. In such an embodiment, the path request signal 114 may bypass that component.

Likewise, the memory controller 106 may include its own path routing circuit 272. In such an embodiment, the path routing circuit 272 may be configured to determine if the data should be returned via the fast path 210 or the slow path 220. In various embodiments, the path routing circuit 272 may honor the path request message 114′. If the path request message 114′ indicates the slow path 220 is to be employed, the path request message 114′ will have the memory controller employ the slow path 220, and likewise with the fast path 210.

However, if the fast path 210 is requested but the path routing circuit 272 determines that using it would be unwise or undesirable, the path routing circuit 272 may select the slow path 220 as the return path. For example, if an uncorrectable error occurs during the read from the memory system 108, the path routing circuit 272 may select to use the slow path 220 and avoid further irregularities. In another embodiment, the path routing circuit 272 may select to use the slow path 220 in order to provide addition read data bandwidth, for example, both the fast path 210 and slow path 220 may be employ substantially simultaneously. Memory Controller can have logic to load balancing service some request using DFP and other by normal path to maximize available data bandwidth. It is understood that the above is merely one illustrative example to which the disclosed subject matter is not limited.

In the illustrated embodiment, the memory controller 106 may include a fast path interface 274 and a slow path interface 276. Each interface 274 and 276 may be configured to return data 116 via their respective paths 210 and 220. Further, the slow path interface 276 may be configured to send the read response signal 228. In some embodiments, the fast path interface 274 may be configured to send the read response signal 218, if such an embodiment employs that signal 218. It is understood that the above are merely a few illustrative examples to which the disclosed subject matter is not limited.

Likewise, in the illustrated embodiment, the processor 102 may include a fast path interface 254 and a slow path interface 256. Each interface 254 and 256 may be configured to receive data 116 via their respective paths 210 and 220. The slow path interface 256 may be configured to also receive the read response signal 228. The fast path interface 254 may be configured to receive the read response signal 218, if such an embodiment employs that signal 218.

FIG. 3 is a block diagram of an example embodiment of a system 300 in accordance with the disclosed subject matter. In the illustrated embodiment, the operation of the system 300 a multi-processor usage case is described.

In the illustrated embodiment, the system 300 may include a processor 102, CDC bridge 103, coherent interconnect 104, CDC bridge 105, memory controller 106, and CDC bridge 207, as described above. In various embodiments, the system 300 may also include the memory system 106, as described above.

In the illustrated embodiment, the system 300 may also include a second processor 302 and a CDC bridge 303 (similar to CDC bridge 103). In the illustrated embodiment, the processor 102 may be aware or configured to make use of the data fast path (DFP) (e.g., fast path 210 of FIG. 2A). Whereas, the second processor 302 may be unaware or not configured to take advantage of the DFP. In various embodiments, the second processor 302 may be a traditional processor that is designed to only use the slow path (e.g., slow path 220 of FIG. 2A) that traverses the interconnect 104. In the case of processor 302 this slow path would include the CDC bridge 30, the interconnect 104, the CDC bridge 105 and the memory controller 106.

In various embodiments, the system 300 may include a plurality of processors, some of which may be able to use either the fast or slow paths, and some that are only able to employ the slow paths. In such an embodiment, the system 300 may include a heterogeneous group of processors. In another embodiment, all of the processors may be aware of the fast and slow paths, and the system 300 may include fast and slow paths for each processor.

In the illustrated embodiment, whenever the second processor 302 issues a read request 312, the slow path may be employed. In various embodiments, the interconnect 104 may be configured, if no path request signal is sent by a processor (e.g., processor 302), to create a path request signal 114′ that requests the slow path. In another embodiment, the path request signal 114′ may have a default value that may be overridden when the fast path is requested.

As described above, in response to the processor 302's read request 312, the memory controller 106 may collect the requested data 116, generate a read response 116, and transmit the signals or messages back via the slow path (signals 316 and 318). In such an embodiment, the coherent interconnect 104 may use the read response 228 to facilitate cache or memory coherency between the processors 102 and 302.

Likewise, when the processor 102 makes a read request 112 and issues a path request 114 to use the slow path, data 116 and read response 118 may be returned via signals 226 and 228. In various embodiments, this may also occur if the coherent interconnect 104 or memory controller 106 deny the request 114 to use the fast path.

In the illustrated embodiment, the processor 102 may issue the read request 112 and indicate (via the path request 114) that the data should be retuned via the fast path, as described above. As described above, the memory controller 106 may send the data 216 back to the requesting processor 102 via the fast path, and send the read response 228 via the slow path.

In such an embodiment, the read response 228 will be received by the processor 102 a number of cycles after the data 216. In such an embodiment, the processor 102 may be configured to make use of the data 216 as soon (or within a reasonable time) as the data 216 is received by the processor 102. In such an embodiment, the data 216 may be passed to the processor 102's core and the execution of the associated instructions may proceed.

Conversely, while the processor 102 may make use of the data 216 for internal uses, it may refrain from using the data 216 for external uses. For example, in a multi-processor system, memory coherency is a important consideration. By receiving the data 216 early (compared to when it would arrive via the slow path) and via the fast path, the coherent interconnect 104 and other processors (processor 302) may not have the correct information to keep the processor memories properly coherent. In such an embodiment, this may be why the read response 118 traverses the slow path, and the data 216 and read response 228 are bifurcated.

In various embodiments, this may occur even if a similar message 218 is sent via the fast path. In such an embodiment, as the read response 228 is processed by the coherent interconnect 104 (and, via the coherent interconnect 104's facilitating functions, processor 302) the caches or memories may have the information they need to remain coherent.

In such an embodiment, the processor 102 may refrain from externally using or replying to requests for information about (e.g., a snoop request) the data 216, until the read response 228 is received via the slow path. In such an embodiment, the information about the processors' caches (not shown) may be synchronized and the caches may be coherently maintained.

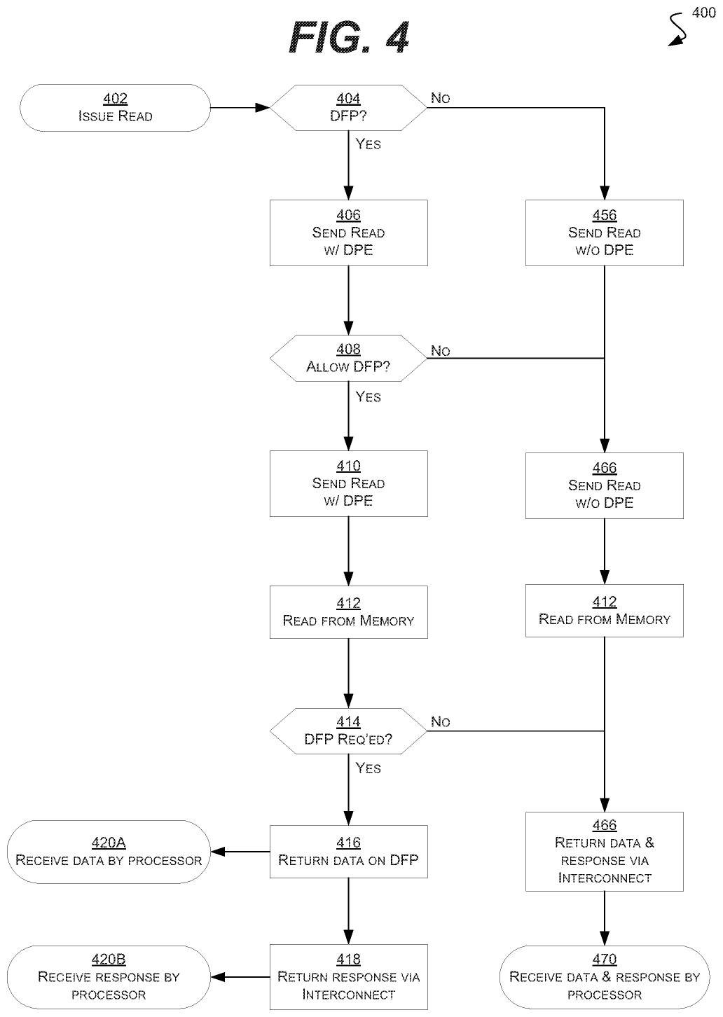

FIG. 4 is a flowchart of an example embodiment of a technique in accordance with the disclosed subject matter. In various embodiments, the technique 400 may be used or produced by the systems such as those of FIG. 1, 2A, 2B, or 3. Although, it is understood that the above are merely a few illustrative examples to which the disclosed subject matter is not limited. It is understood that the disclosed subject matter is not limited to the ordering of or number of actions illustrated by technique 400.

Block 402 illustrates that, in one embodiment, a requesting processor or entity may wish to issue a read request, as described above. Block 404 illustrates that, in one embodiment, the processor or requesting entity may determine if use of the data fast path (DFP) is desirable or even possible. In various embodiments, the requesting processor may determine that the DFP is not desirable in cases, such as, for example: a case where low power is more critical than lowest memory access latency, as using the data fast path may consume extra energy; when the DFP is throttled due to temporary congestion; or when the requester wants to have additional bandwidth (both DFP and normal path). It is understood that the above are merely a few illustrative examples to which the disclosed subject matter is not limited.

Block 406 illustrates that, in one embodiment, if the DFP is to be employed, the processor may issue or send the read request and may include a path request signal with asks for the fast path to be employed, as described above. Conversely, block 456 illustrates that, in one embodiment, if the DFP is not to be employed, the processor may issue or send the read request and may include a path request signal with asks for the slow path to be employed, as described above.

Block 408 illustrates that, in one embodiment, an intervening device (e.g., the coherent interconnect) may determine whether or not to allow, dent, grant, or override, the path request, as described above.

Block 410 illustrates that, in one embodiment, if the request to use the DFP is granted, the intervening device may forward or send the read request and the path request signal, as described above. Conversely, block 466 illustrates that, in one embodiment, if the request to sue DFP is not allowed (block 408) or was never requested (block 456), the processor may issue or send the read request and may include a path request signal with asks for the slow path to be employed, as described above.

Block 412 illustrates that, in one embodiment, the read request may be processed by reading from the target memory address. In various embodiments, this may include the memory controller reading from the memory system or main memory, as described above.

Block 414 illustrates that, in one embodiment, the memory controller may determine if the fast path is requested and should be used. As described above. the memory controller may deny or grant a request to employ the fast path, and instead send the data back on the slow path.

Block 416 illustrates that, in one embodiment, that if the fast path is to be used, the data may be returned via the fast path, as described above. Block 418 illustrates that, in one embodiment, that even if the fast path is to be employed for returning the data, the slow path may be employed for returning the read response, as described above. In such an embodiment, a signal (e.g., RdVal=0) may indicate to the processor or interconnect if data bus on the slow path does not have valid data.

Block 420A illustrates that, in one embodiment, if the fast path is being used, the data may be received by the processor first or earlier than if it had gone via the slow path, as described above. Block 420B illustrates that, in one embodiment, even if the fast path is being used, the read response may be received by the processor second or at the same time as it would have been received if the data had also gone via the slow path, as described above.

Block 466 illustrates that, in one embodiment, if the slow path is employed, both the data and the read response may be transmitted to the processor via the slow path. In such an embodiment, a signal (e.g., RdVal=1) may indicate to the processor or interconnect if data bus on the slow path has valid data. Block 470 illustrates that, in one embodiment, both the data and read response message may be received by the processor at substantially the same time.

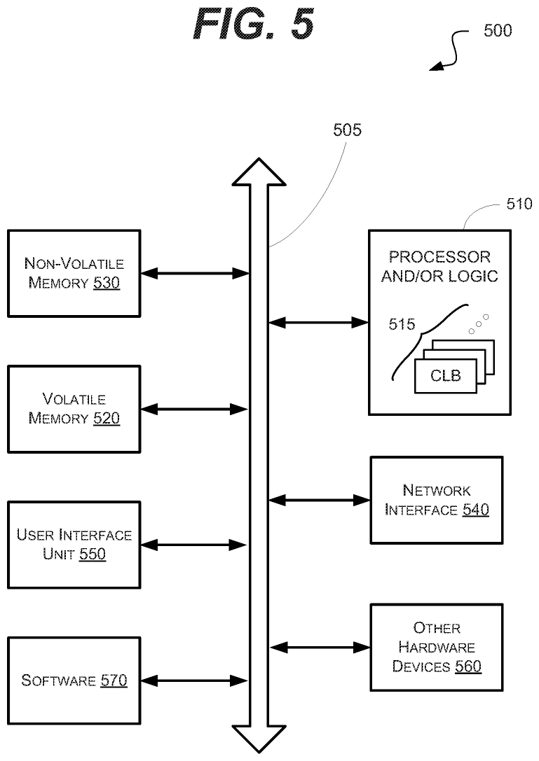

FIG. 5 is a schematic block diagram of an information processing system 500, which may include semiconductor devices formed according to principles of the disclosed subject matter.

Referring to FIG. 5, an information processing system 500 may include one or more of devices constructed according to the principles of the disclosed subject matter. In another embodiment, the information processing system 500 may employ or execute one or more techniques according to the principles of the disclosed subject matter.

In various embodiments, the information processing system 500 may include a computing device, such as, for example, a laptop, desktop, workstation, server, blade server, personal digital assistant, smartphone, tablet, and other appropriate computers or a virtual machine or virtual computing device thereof. In various embodiments, the information processing system 500 may be used by a user (not shown).

The information processing system 500 according to the disclosed subject matter may further include a central processing unit (CPU), logic, or processor 510. In some embodiments, the processor 510 may include one or more functional unit blocks (FUBs) or combinational logic blocks (CLBs) 515. In such an embodiment, a combinational logic block may include various Boolean logic operations (e.g., NAND, NOR, NOT, XOR), stabilizing logic devices (e.g., flip-flops, latches), other logic devices, or a combination thereof. These combinational logic operations may be configured in simple or complex fashion to process input signals to achieve a desired result. It is understood that while a few illustrative examples of synchronous combinational logic operations are described, the disclosed subject matter is not so limited and may include asynchronous operations, or a mixture thereof. In one embodiment, the combinational logic operations may comprise a plurality of complementary metal oxide semiconductors (CMOS) transistors. In various embodiments, these CMOS transistors may be arranged into gates that perform the logical operations; although it is understood that other technologies may be used and are within the scope of the disclosed subject matter.

The information processing system 500 according to the disclosed subject matter may further include a volatile memory 520 (e.g., a Random Access Memory (RAM)). The information processing system 500 according to the disclosed subject matter may further include a non-volatile memory 530 (e.g., a hard drive, an optical memory, a NAND or Flash memory). In some embodiments, either the volatile memory 520, the non-volatile memory 530, or a combination or portions thereof may be referred to as a “storage medium”. In various embodiments, the volatile memory 520 and/or the non-volatile memory 530 may be configured to store data in a semi-permanent or substantially permanent form.

In various embodiments, the information processing system 500 may include one or more network interfaces 540 configured to allow the information processing system 500 to be part of and communicate via a communications network. Examples of a Wi-Fi protocol may include, but are not limited to, Institute of Electrical and Electronics Engineers (IEEE) 802.11g, IEEE 802.11n. Examples of a cellular protocol may include, but are not limited to: IEEE 802.16m (a.k.a. Wireless-MAN (Metropolitan Area Network) Advanced, Long Term Evolution (LTE) Advanced, Enhanced Data rates for GSM (Global System for Mobile Communications) Evolution (EDGE), Evolved High-Speed Packet Access (HSPA+). Examples of a wired protocol may include, but are not limited to, IEEE 802.3 (a.k.a. Ethernet), Fibre Channel, Power Line communication (e.g., HomePlug, IEEE 1901). It is understood that the above are merely a few illustrative examples to which the disclosed subject matter is not limited.

The information processing system 500 according to the disclosed subject matter may further include a user interface unit 550 (e.g., a display adapter, a haptic interface, a human interface device). In various embodiments, this user interface unit 550 may be configured to either receive input from a user and/or provide output to a user. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

In various embodiments, the information processing system 500 may include one or more other devices or hardware components 560 (e.g., a display or monitor, a keyboard, a mouse, a camera, a fingerprint reader, a video processor). It is understood that the above are merely a few illustrative examples to which the disclosed subject matter is not limited.

The information processing system 500 according to the disclosed subject matter may further include one or more system buses 505. In such an embodiment, the system bus 505 may be configured to communicatively couple the processor 510, the volatile memory 520, the non-volatile memory 530, the network interface 540, the user interface unit 550, and one or more hardware components 560. Data processed by the processor 510 or data inputted from outside of the non-volatile memory 530 may be stored in either the non-volatile memory 530 or the volatile memory 520.

In various embodiments, the information processing system 500 may include or execute one or more software components 570. In some embodiments, the software components 570 may include an operating system (OS) and/or an application. In some embodiments, the OS may be configured to provide one or more services to an application and manage or act as an intermediary between the application and the various hardware components (e.g., the processor 510, a network interface 540) of the information processing system 500. In such an embodiment, the information processing system 500 may include one or more native applications, which may be installed locally (e.g., within the non-volatile memory 530) and configured to be executed directly by the processor 510 and directly interact with the OS. In such an embodiment, the native applications may include pre-compiled machine executable code. In some embodiments, the native applications may include a script interpreter (e.g., C shell (csh), AppleScript, AutoHotkey) or a virtual execution machine (VM) (e.g., the Java Virtual Machine, the Microsoft Common Language Runtime) that are configured to translate source or object code into executable code which is then executed by the processor 510.

The semiconductor devices described above may be encapsulated using various packaging techniques. For example, semiconductor devices constructed according to principles of the disclosed subject matter may be encapsulated using any one of a package on package (POP) technique, a ball grid arrays (BGAs) technique, a chip scale packages (CSPs) technique, a plastic leaded chip carrier (PLCC) technique, a plastic dual in-line package (PDIP) technique, a die in waffle pack technique, a die in wafer form technique, a chip on board (COB) technique, a ceramic dual in-line package (CERDIP) technique, a plastic metric quad flat package (PMQFP) technique, a plastic quad flat package (PQFP) technique, a small outline package (SOIC) technique, a shrink small outline package (SSOP) technique, a thin small outline package (TSOP) technique, a thin quad flat package (TQFP) technique, a system in package (SIP) technique, a multi-chip package (MCP) technique, a wafer-level fabricated package (WFP) technique, a wafer-level processed stack package (WSP) technique, or other technique as will be known to those skilled in the art.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

In various embodiments, a computer readable medium may include instructions that, when executed, cause a device to perform at least a portion of the method steps. In some embodiments, the computer readable medium may be included in a magnetic medium, optical medium, other medium, or a combination thereof (e.g., CD-ROM, hard drive, a read-only memory, a flash drive). In such an embodiment, the computer readable medium may be a tangibly and non-transitorily embodied article of manufacture.

While the principles of the disclosed subject matter have been described with reference to example embodiments, it will be apparent to those skilled in the art that various changes and modifications may be made thereto without departing from the spirit and scope of these disclosed concepts. Therefore, it should be understood that the above embodiments are not limiting, but are illustrative only. Thus, the scope of the disclosed concepts are to be determined by the broadest permissible interpretation of the following claims and their equivalents, and should not be restricted or limited by the foregoing description. It is, therefore, to be understood that the appended claims are intended to cover all such modifications and changes as fall within the scope of the embodiments.

1. An apparatus comprising:
a processor;
a memory controller; and
a coherent interconnect coupled, via at least a first path, in between the processor and the memory controller; and
wherein the processor is coupled with the memory controller via the first path and a second path,
wherein the first path traverses the coherent interconnect that couples the memory controller with a plurality of processors, including the processor, and
wherein the second path bypasses the coherent interconnect and has a lower latency than the first path;
wherein the processor is configured to send a memory access request to the memory controller and wherein the memory access request includes a path request to employ either the first path or the second path; and
the memory controller configured to fulfill the memory access request and, based at least in part upon the path request, send at least part of results of a memory access to the processor via either the first path or the second path.

2. The apparatus of claim 1, further including:
the coherent interconnect, wherein the coherent interconnect is configured to, based on predefined criteria, block or forward the path request to the memory controller.

3. The apparatus of claim 2, further including:
a second processor, included by the plurality of processors; and
wherein the coherent interconnect is configured to block the path request if a copy of a data associated with the memory access is stored by the second processor.

4. The apparatus of claim 2, wherein the first path traverses a first clock-domain-bridge that synchronizes data between a first clock employed by the processor and a second clock employed by the coherent interconnect, and a second clock-domain-bridge that synchronizes data between the second clock employed by the coherent interconnect and a third clock employed by the memory controller; and
wherein the second path traverses a third clock-domain-bridge that synchronizes data between the first clock employed by processor and the third clock employed by memory controller.

5. The apparatus of claim 1, wherein the memory controller is configured to fulfill the memory access request via the first path despite a path request to employ the second path, if an error occurs while fulfilling the memory access request.

6. The apparatus of claim 1, wherein the memory controller is configured to, when sending at least part of the results of the memory access via the second path, to:
send data associated with the memory access to the processor via the second path, and
send a response message associated with the memory access to the processor via the first path.

7. The apparatus of claim 6, wherein the processor is configured to:
consume the data upon arrival via the second path, but
not respond to a snoop request associated with the data until the response message arrives via the first path.

8. The apparatus of claim 6, wherein the memory controller is configured to send a second response message associated with the memory access to the processor via the second path.

9. The apparatus of claim 1, wherein the plurality of processors includes a heterogeneous plurality of processors that include:
the processor configured to employ either the first path or second path for memory accesses, and
a second processor configured to only employ the first path for memory accesses.

10. A system comprising:
a plurality of processors coupled with a memory controller via at least a slow path,
wherein at least a requesting processor of the plurality of processors is coupled with the memory controller via both the slow path and a fast path,
wherein the slow path traverses a coherent interconnect that couples the memory controller with the plurality of processors, and
wherein the fast path bypasses the coherent interconnect and has a lower latency than the slow path;
the coherent interconnect configured to couple the plurality of processors with a memory controller and facilitate cache coherency between the plurality of processors; and
the memory controller configured to fulfill a memory access request from the requesting processor, and, based at least in part upon a path request message, send at least part of the results of memory access to the requesting processor via either the slow path or the fast path.

11. The system of claim 10, wherein the coherent interconnect is configured to, if the requesting processor transmitted a path request message, based on predefined criteria, block or forward the path request message to the memory controller.

12. The system of claim 11, wherein the coherent interconnect is configured to block the path request based, at least in part, upon a load balancing between the fast path and the slow path.

13. The system of claim 11, wherein a respective slow path associated with a respective processor of the plurality of processors traverses a first clock-domain-bridge that synchronizes data between a first clock employed by the respective processor and a second clock employed by the coherent interconnect, and a second clock-domain-bridge that synchronizes data between the second clock employed by the coherent interconnect and a third clock employed by the memory controller; and
wherein the fast path traverses a third clock-domain-bridge that synchronizes data between the first clock employed by the respective processor and the third clock employed by the memory controller.

14. The system of claim 10, wherein the memory controller is configured to fulfill the memory access request via the slow path despite a path request message to employ the fast path, if the memory controller detects congestion on the fast path.

15. The system of claim 10, wherein the memory controller is configured to, when sending at least part of the results of the memory access via the fast path, to:
send data associated with the memory access to the requesting processor via the fast path, and
send a response message associated with the memory access to the requesting processor via the slow path.

16. The system of claim 15, wherein the requesting processor is configured to:
consume the data upon arrival via the fast path, but
not respond to a snoop request associated with the data until the response message arrives via the slow path.

17. The system of claim 10, wherein the memory controller is configured to send a second response message associated with the memory access to the requesting processor via the fast path.

18. The system of claim 10, wherein the plurality of processors includes a second processor coupled with the slow path but not the fast path, and configured to only employ the slow path for memory accesses.

19. A memory controller comprising:
a slow path interface configured to, in response to a memory access, send at least a response message to a requesting processor,
wherein the slow path traverses a coherent interconnect that couples the memory controller with a requesting processor;
a fast path interface configured to, at least partially in response to the memory access, send data to a requesting processor; and
wherein the fast path coupled the memory controller with the requesting processor, and bypasses the coherent interconnect, and wherein the fast path has a lower latency that the slow path;
a path routing circuit configured to:
receive, as part of the memory access, a data path request from the coherent interconnect, and
based at least in part upon a result of the memory access and the data path request, determine whether the data is to be sent via the slow path or the fast path; and
wherein the memory controller is configured to:
if the path routing circuit determines that data is to be sent via the slow path, send both the data and the response message to the requesting processor via the slow path interface, and
if the path routing circuit determines that the data is to be sent via the fast path, send the data to the requesting processor via the fast path interface, and the response message to the requesting processor via the slow path interface.

20. The memory controller of claim 19, wherein the path routing circuit is configured to, if the memory access resulted in an error, determine that the data is to be sent via the slow path regardless of the data path request.
